(19) United States
(12) Patent Application Publication
(10) Pub. No.: US 2012/0225410 A1
(43) Pub. Date: Sep. 6, 2012

(54) Idea/process of combining a cross stitch / needlepoint / crewl design / pattern with hand painting the cloth / canvas as part of the pattern offered, or as an option, and also as a solution to repair an existing tapestry from stains or any type of damage

(76) Inventor: Paula Marie Constance Howard, Indian Head Park, IL (US)

(21) Appl. No.: 13/038,602

(22) Filed: Mar. 2, 2011

(51) Int. Cl. G09B 11/00

(52) U.S. Cl. 434/81

(57) ABSTRACT

The purpose and process of combining cross stitch, needlepoint or crewel patterns with hand painting the cloth or canvas as part of the pattern designed and/or as a repair solution to a damaged tapestry.

Written Description: The idea/process of combining a cross stitch/needlepoint/crewel design/pattern with hand painting the cloth/canvas as part of the pattern offered, or as an option, and also as a solution to repair an existing tapestry from stains or any type of damage.

Making and Using Invention: The Pattern includes the stitches required for a tapestry design and the products and instruction to Use, Where and How to apply the paint to complete said pattern. Any type or color of Fabric Paint can be used and 3 coats can be applied for the best coverage. The paint can be used anywhere within the pattern as specified by the design/pattern being offered by Paula Howard or Paula's Patterns.

Best Mode: The best way to carry this out is through the instructions given with said patterns and part of the design. Instructions will include How, Where and What products and colors to be used.

Brief Descriptions:

“Instruction” (1) (a) Instruction page 1

“Instruction” (1) (b) Instruction page 2

### Hand Painting Instructions:

Hand Paint all remaining cloth/canvas with Tulip (Matte) soft fabric paint—Glacier White (color)—apply 3 coats allowing 4 hours between each coat given. It is optional if you paint completely up to the threads or leave one square around the cross stitch pattern.

“Instruction”(1) (b)

1) the right of an inventor in the idea of combining cross stitch and hand painting in one pattern.

2) to the right of an inventor in the idea of combining needlepointing and hand painting in one pattern.

3) to the right of an inventor in the idea of combining crewel and hand painting in one pattern.

4) to the right of using hand painting an existing tapestry of any type to repair damage and stains of any type.

5) to the right of any capacity of hand painting a cloth used in combination with any type of needlework art.
